(19) United States
(12) Patent Application Publication
(10) Pub. No.: US 2025/0269574 A1
(43) Pub. Date: Aug. 28, 2025

(54) MOLDING MANAGEMENT SYSTEM

(71) Applicant: SEIKO EPSON CORPORATION, Tokyo (JP)

(72) Inventors: Kosuke ATSUTA, SHIOJIRI-SHI (JP); Soji SHIOZAWA, MATSUMOTO-SHI (JP)

(21) Appl. No.: 19/064,149

(22) Filed: Feb. 26, 2025

(30) Foreign Application Priority Data
Feb. 28, 2024 (JP) 2024-028392

(51) Int. Cl. B29C 45/76

(52) U.S. Cl. CPC B29C 45/76; B29C 2045/7606; B29C 2945/76939

(57) ABSTRACT

A molding management system including a server communicably connected to a terminal device, the molding management system managing production of a product in a production process including an injection molding process for the product by an injection molding device, wherein the server includes: a storage unit configured to store one or more pieces of lot information in which lot identification information for identifying a lot of the product and lot related information including history information indicating a history concerning the product of at least the lot as one or more pieces of information concerning the lot of the product are associated with each other; and a control unit configured to cause the terminal device to display a history information display image for displaying the history information included in the lot related information of the lot information indicating a selected target lot among the lots indicated by the one or more pieces of lot information stored in the storage unit.

The present application is based on, and claims priority from JP Application Serial Number 2024-028392, filed Feb. 28, 2024, the disclosure of which is hereby incorporated by reference herein in its entirety.

### BACKGROUND

### 1. Technical Field

The present disclosure relates to a molding management system.

### 2. Related Art

A technique for managing production of a product in a production process including an injection molding process of the product by an injection molding device using a resin material such as plastic has been studied and developed.

Concerning the technique, there is known a molding management system that can store information indicating histories concerning the quality of a molded product for each shot in an injection molding device that molds a product, an operation state of the injection molding device, a setting change to the injection molding device, and the like and display the stored information at desired timing (see JP-A-2003-094503).

JP-A-2003-094503 is an example of the related art.

Here, in the molding management system described in JP-A-2003-094503, information indicating pressure, temperature, force, and the like for each shot in the injection molding device that molds the molded product is stored as the information indicating the history concerning the quality of the molded product. That is, in the molding management system, information indicating a history concerning inspection of the quality of a molded product is not stored. In the molding management system, the information indicating the history concerning the operation state of the injection molding device, the setting change to the injection molding device, and the like is also information indicating a history concerning the injection molding device like the information indicating the history concerning the quality of the molded product. Therefore, in the molding management system, the display of the information indicating the history concerning the molded product was insufficient. This means that traceability about the molded product is insufficient, which is not desirable.

### SUMMARY

In order to solve the problems described above, an aspect of the present disclosure is a molding management system including a server communicably connected to a terminal device, the molding management system managing production of a product in a production process including an injection molding process for the product by an injection molding device, wherein the server includes: a storage unit configured to store one or more pieces of lot information in which lot identification information for identifying a lot of the product and lot related information including history information indicating a history concerning the product of at least the lot as one or more pieces of information concerning the lot of the product are associated with each other; and a control unit configured to cause the terminal device to display a history information display image for displaying the history information included in the lot related information of the lot information indicating a selected target lot among the lots indicated by the one or more pieces of lot information stored in the storage unit.

In order to solves the problems described above, an aspect of the present disclosure is a molding management system including a server communicably connected to a terminal device, the molding management system managing production of a product in a production process including an injection molding process for the product by an injection molding device, wherein the server includes: a storage unit configured to store one or more pieces of lot information in which lot identification information for identifying a lot of the product and lot related information including first history information indicating a history of a first type concerning at least the lot as one or more pieces of information concerning the lot of the product and second history information indicating a history of a second type concerning the lot are associated with each other; and a control unit configured to cause the terminal device to display a history information display image for displaying the first history information and the second history information included in the lot related information of the lot information indicating a selected target lot among the lots indicated by the one or more pieces of lot information stored in the storage unit.

### BRIEF DESCRIPTION OF THE DRAWINGS

FIG. 1 is a diagram illustrating an example of a configuration of a molding management system 1.

FIG. 2 is a diagram illustrating an example of a main menu image P1.

FIG. 3 is a diagram illustrating an example of a terminal image P2.

FIG. 4 is a diagram illustrating an example of a lot search image P3.

FIG. 5 is a diagram illustrating an example of an overall image of a history information display image P4 displayed when selection operation on a button B41 illustrated in FIG. 4 is performed.

FIG. 6 is an enlarged view of a display region RG41 illustrated in FIG. 5.

FIG. 7 is an enlarged view of a display region RG42 illustrated in FIG. 5.

FIG. 8 is an enlarged view of a display region RG43 illustrated in FIG. 5.

FIG. 9 is an enlarged view of a display region RG44 illustrated in FIG. 5.

FIG. 10 is a diagram illustrating an example of a quality inspection history information display image P5 displayed by a server 30 when selection operation on a button B51 illustrated in FIG. 5 is performed.

FIG. 11 is a diagram illustrating an example of a history information display operation reception image P6.

FIG. 12 is a diagram illustrating an example of a hardware configuration of the server 30.

FIG. 13 is a diagram illustrating an example of a functional configuration of the server 30.

FIG. 14 is a diagram illustrating an example of a flow of processing in which the server 30 displays the history information display image P4.

### DESCRIPTION OF EMBODIMENTS

### Embodiment

An embodiment of the present disclosure is explained below with reference to the drawings.

### Overview of a Molding Management System

First, an overview of a molding management system according to the embodiment is explained.

The molding management system according to the embodiment manages production of a product in a production process including an injection molding process of the product by an injection molding device. The molding management system includes a server. The server is communicably connected to a terminal device. The server includes a storage unit and a control unit. The storage unit stores one or more pieces of lot information in which lot identification information for identifying a lot of a product and lot related information including at least history information as one or more pieces of information concerning the lot of the product are associated with each other. Here, the history information means information indicating a history concerning the product of the lot. The control unit causes the terminal device to display a history information display image for displaying history information included in lot related information of lot information indicating a selected target lot among lots indicated by the one or more pieces of lot information stored in the storage unit.

Accordingly, the molding management system according to the embodiment can improve traceability about a molded product.

In the following explanation, each of a configuration of the molding management system according to the embodiment and processing performed by the server included in the molding management system is explained in detail.

When the traceability about the product is insufficient, good or bad determination for the product in the case in which a quality problem occurs cannot be accurately performed. All of lots including products which may be non-defective products are sometimes discarded or suspended. In order to prevent this when the traceability is insufficient, it is necessary to perform reinspection of all the lots. However, the reinspection of all lots takes time and cost and is not desirable. For this reason, it is useful to be able to improve traceability about a molded product as in the molding management system according to the embodiment.

### Configuration of the Molding Management System

The configuration of the molding management system according to the embodiment is explained below by taking a molding management system 1 as an example.

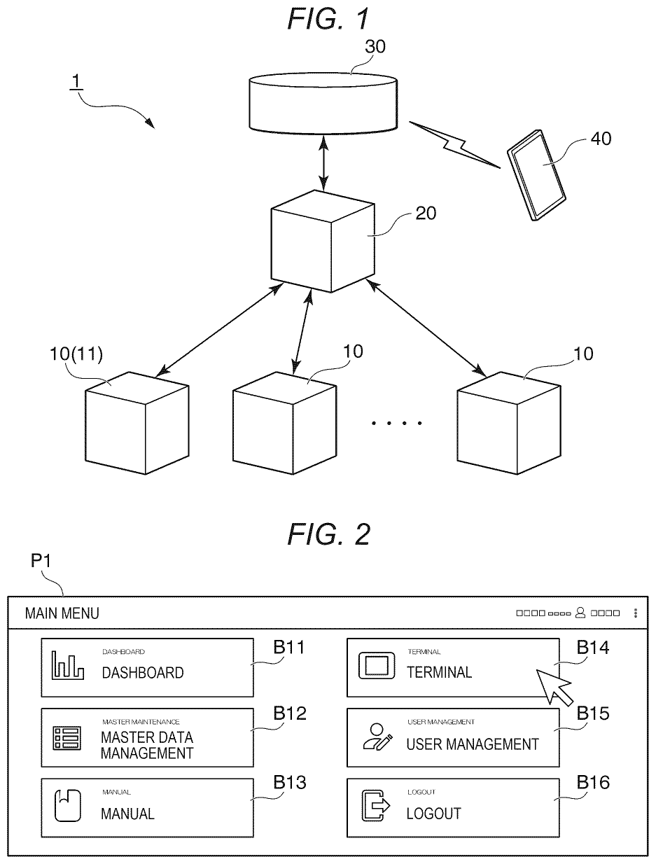

FIG. 1 is a diagram illustrating an example of a configuration of the molding management system 1.

The molding management system 1 is a kind of a manufacturing execution system (MES). For example, the molding management system 1 includes one or more managed devices 10, an information processing device 20, and a server 30. The molding management system 1 may be configured not to include a part or all of the one or more managed devices 10. The molding management system 1 may not include the information processing device 20. In the following explanation, as an example, a case in which the molding management system 1 includes a plurality of managed devices 10 as the one or more managed devices 10 is explained.

Each of the plurality of managed devices 10 provided in the molding management system 1 is a device managed by the molding management system 1. In FIG. 1, for convenience of explanation, the respective plurality of managed devices 10 are indicated by the same reference numerals and signs. However, a part or all of the plurality of managed devices 10 may be devices of types different from one another. The plurality of managed devices 10 include at least one injection molding device that performs injection molding of a product using resin such as plastic. An injection molding device 11 illustrated in FIG. 1 is an example of such an injection molding device. The plurality of managed devices 10 may include an injection molding device that performs metal injection molding (MIM) of a product. In the following explanation, for convenience of explanation, injection molding of a product using resin such as plastic is simply referred to as injection molding. In the following explanation, an injection molding device that performs injection molding of a product using a resin such as plastic is simply referred to as injection molding device. In addition to the injection molding device, the plurality of managed devices 10 include, for example, peripheral equipment of the injection molding device. Examples of the peripheral equipment of the injection molding device include, but are not limited to, a material supply device that supplies a material used by an injection molding device for injection molding of a product to the injection molding device, a conveying device that transports a product injection-molded by an injection molding device, a cleaning device that cleans a product injection-molded by an injection molding device, and a sintering device that sinters a product after being cleaned by a cleaning device. At least one injection molding device included in the plurality of managed devices 10 may be a device that performs injection molding using a material other than resin and metal.

The molding management system 1 manages production of products in a production process including an injection molding process of a product by an injection molding device included in the plurality of managed devices 10. The injection molding device included in the plurality of managed devices 10 may have any configuration if the configuration is capable of producing a product by injection molding. In the following explanation, for convenience of explanation, one time of injection molding of a product by the injection molding device is referred to as one shot. In this case, for example, two shots are two times of injection molding of the product by the injection molding device. In the following explanation, for convenience of explanation, each of one or more hollows in a die filled with resin in molding the product in one shot is referred to as cavity. For example, an injection molding device to which a die having two such hollows is attached molds two products with one shot.

The information processing device 20 acquires, for each of the plurality of managed devices 10, state information indicating a state of the managed device 10 from the managed device 10. For example, the information processing device 20 acquires state information about the injection molding device 11 from the injection molding device 11. Such state information includes a time stamp indicating a date and time when the state information was acquired by the information processing device 20. Certain state information includes device identification information for identifying the managed device 10 in the state indicated by the state information. The state information includes detection information detected by each of one or more various sensors attached to the managed device 10. The detection information includes, for example, information indicating a temperature, information indicating a pressure, information indicating a current value, and information indicating a voltage value. That is, examples of the one or more various sensors include, but are not limited to, a thermometer, a pressure gauge, an ammeter, and a voltmeter. The detection information may include other information detected by the sensor instead of a part or all of these pieces of information or in addition to all of these pieces of information. The state information includes operation state information indicating an operation state of the managed device 10. The operation state information indicating the operation state of the managed device 10 may be any information if the operation state information is information including information indicating whether the managed device 10 is operating. The acquisition of the state information by the information processing device 20 may be periodically performed or may be non-periodically performed. In the following explanation, as an example, a case in which the acquisition of the state information by the information processing device 20 is performed every time the one shot explained above is performed is explained. When acquiring certain state information, the information processing device 20 outputs the acquired state information to the server 30. Accordingly, the information processing device 20 can cause the server 30 to store the acquired state information.

Examples of the information processing device 20 include, but are not limited to, a workstation, a desktop PC (Personal Computer), and a notebook PC. The information processing device 20 is communicably connected to each of the plurality of managed devices 10 by wired or wireless communication. Examples of a communication network that connects the information processing device 20 and each of the plurality of managed devices 10 include, but are not limited to, a Local Area Network (LAN) in a facility in which the plurality of managed devices 10 are installed. The communication network may be another communication network such as the Internet or a mobile communication network.

The server 30 stores the state information acquired by the information processing device 20. For example, when acquiring certain state information from the information processing device 20, the server 30 stores the acquired state information. Here, when the server 30 has already stored state information including device identification information included in the state information, the server 30 replaces the already stored state information with the state information acquired anew. Accordingly, the server 30 can always keep, as the latest state information, the state information indicating the state of the managed device 10 indicated by the device identification information. The server 30 may be configured to store all pieces of acquired state information without performing such replacement. The server 30 may be configured to store the state information before replacement as history information indicating a history of the state of the managed device 10 again even when the server 30 performs such replacement.

According to a request from a terminal device communicably connected to the server 30, the server 30 causes a display unit of the terminal device to display various images based on the state information stored by the server 30. Here, the images are a graphical user interface (GUI), an icon, a window on an operating system (OS), and the like. In the following explanation, as an example, as illustrated in FIG. 1, a case in which the server 30 is communicably connected to a terminal device 40 is explained. In the present embodiment, since processing related to login to the server 30 by the terminal device 40 is known processing, explanation of the processing is omitted. In the following explanation, for convenience of explanation, the server 30 receiving operation from the terminal device 40 via an image displayed on the terminal device 40 is simply referred to as the server 30 receiving operation. That is, in the following explanation, the server 30 performing certain processing according to the received operation means that the server 30 performs the processing according to operation received from the terminal device 40 via the image displayed on the terminal device 40.

The server 30 also receives various information according to the received operation. For example, according to the received operation, the server 30 stores master data including various information about a product by the injection molding device 11. The master data includes, for example, product identification information for identifying various products produced by the injection molding device 11, product type information indicating types of products identified by respective kinds of product identification information, production quantity plan value information indicating planned values of production quantities of the products identified by the respective kinds of product identification information, and die identification information for identifying dies used for production of the products identified by the respective kinds of product identification information. A data structure of the master data may be any structure. For example, the various information included in the master data are included in the master data as information associated with the product identification information. The various information included in the master data may be, instead of the information associated with the product identification information, information associated with the product type information, may be information associated with both of the product identification information and the product type information, or may be information associated with other information.

According to the received operation, the server 30 causes the display unit of the terminal device 40 to display a lot search image for receiving lot search operation for searching for a lot of a product. Examples of the display unit include, but are not limited to, a display of the terminal device 40 and a display device communicably connected to the terminal device 40. In the following explanation, as an example, a case in which the display unit is a display of the terminal device 40 is explained. In the following explanation, for convenience of explanation, causing the display unit to display a certain image is referred to as causing to display the image. The lot search image is an image for receiving, with lot search operation explained above, various information usable as a search key. In the following explanation, for convenience of explanation, a lot of a product is simply referred to as lot. The lot is a group of one or more products to which lot identification information is allocated for a reason of management. For this reason, in the following explanation, for convenience of explanation, a product to which lot identification information for identifying a certain lot is allocated is referred to as product of the lot. The lot identification information may be any information if the information is information capable of identifying a lot and may be, for example, an identifier (ID) for identifying a lot, a character string for identifying a lot, or other information capable of identifying a lot.

Here, the server 30 stores lot identification information and lot related information including one or more pieces of information concerning a lot in association with each other. Accordingly, in the server 30, when information concerning a product of a certain lot is searched, together with lot identification information for identifying the lot, each of one or more pieces of information included in lot related information associated with the lot identification information can also be used as a search key for searching for the lot. In other words, in the lot search image, in addition to the lot identification information, one or more pieces of information included in the lot related information can be used as the search key used for the search for the lot. In the following explanation, for convenience of explanation, information in which lot identification information for identifying a certain lot and lot related information including one or more pieces of information concerning the lot are associated is referred to as lot information indicating the lot. That is, when receiving at least one piece of information among one or more pieces of information included in the lot related information via the lot search image with the lot search operation, the server 30 displays lot information indicating a lot identified by each of one or more pieces of lot identification information associated with the received at least one piece of information. Accordingly, the server 30 can easily cause a user to search for information of a product of a lot desired by the user. For this reason, the server 30 stores one or more pieces of lot information for each of pieces the lot identification information. Here, the lot information is, for example, information generated or updated by information received from the user via one of update system functions executable by the server 30 and is information stored in the server 30. Certain lot information includes, for example, lot identification information for identifying a lot indicated by the lot information and lot related information about the lot. More specifically, the lot related information includes number of products information indicating the number of products of the lot, product type information indicating the type of the product of the lot, process information indicating a work process currently performed on the product of the lot, lot state information indicating a state of the lot, start date and time information indicating a date and time when the production of the product of the lot was started, quality information indicating a result of quality inspection performed on the product of the lot, injection molding device related information concerning an injection molding device that performs molding of the product of the lot, die identification information for identifying a die attached to the injection molding device, number of cavities information indicating the number of cavities of the die, and history information concerning the product of the lot. The lot related information may include other information concerning the lot instead of a part or all of these kinds of information or in addition to all of these kinds of information. However, in the following explanation, a case in which at least the history information is included in the lot information is explained as an example. The quality information is information indicating that, when quality inspection for the product is not performed, the quality inspection for the product is not performed. The injection molding device related information means, for example, information including injection molding device identification information for identifying the injection molding device, operation state information indicating an operation state of the injection molding device, and detection information about the injection molding device. The history information means information including lot information change history information indicating a history concerning a change of the lot information, material history information indicating a history concerning use of a material of the product of the lot, work process change history information indicating a history concerning a change of a work process performed on the product of the lot, lot management history information indicating a history concerning management of the lot, and quality inspection history information indicating a history concerning inspection of the quality of the product of the lot. The history information may include, instead of a part or all of these kinds of information or in addition to all of these kinds of information, other information concerning the product of the lot.

A method of causing the server 30 to store the various information included in the lot related information as lot information in association with lot identification information may be a known method such as a method via a GUI or may be a method to be developed in future. In the following explanation, in order to simplify the explanation, a case in which one or more pieces of lot information is stored in advance in the server 30 is explained as an example. This means that the history information explained above is stored in the server 30 in advance.

In the following explanation, for convenience of explanation, a group of one or more materials to which material lot identification information is allocated for the reason of management is referred to as material lot. That is, the material lot identification information means information for identifying a material lot. In the following explanation, for convenience of explanation, a material to which material lot identification information for identifying a certain material lot is allocated is referred to as material of the material lot. In general, the material lot identification information is often allocated by a material manufacturer side. However, the material lot identification information is not limited to this and may be other information capable of identifying the material lot.

According to received operation, the server 30 displays a history information display image for displaying history information included in lot related information of lot information indicating a selected target lot among the one or more pieces of lot information stored in the server 30.

For example, the server 30 displays the history information display image by receiving operation via the main menu image P1 illustrated in FIG. 2. FIG. 2 is a diagram illustrating an example of the main menu image P1.

When receiving predetermined main menu image display operation, the server 30 displays the main menu image P1. In the example illustrated in FIG. 2, the main menu image P1 includes six buttons B11 to B16.

The button B11 is a button for displaying a dashboard image. When receiving selection operation on the button B11, the server 30 generates a dashboard image and displays the generated dashboard image. Here, the dashboard image is an image in which information necessary for the user to manage production of a product by the injection molding device is displayed during operation of an injection molding device designated by the user of the terminal device 40. In the present embodiment, the selection operation means a click, a tap, or the like but are not limited to these.

The button B12 is a button for displaying a master data management image. When receiving selection operation on the button B12, the server 30 generates a master data management image and displays the generated master data management image. The master data management image is an image for receiving operation of, for example, inputting, changing, and deleting the master data explained above. The server 30 can, for example, generate, change, delete the master data according to operation on the master data management image. When master data is generated, the server 30 stores the generated master data. When the master data is changed, the server 30 updates the stored master data to the changed master data.

The button B13 is a button for displaying a manual image. When receiving selection operation on the button B13, the server 30 generates a manual image and displays the generated manual image. Here, the manual image is an image for receiving operation of displaying a manual for an operation method of the molding management system 1.

The button B14 is a button for displaying a terminal image P2. When receiving selection operation on the button B14, the server 30 generates the terminal image P2 and displays the generated terminal image P2. Here, the terminal image P2 is an image for receiving operation for executing each of various update system functions of the server 30. In other words, the terminal image P2 means an image for receiving operation of displaying a desired image among images for receiving operation for each of a plurality of update system functions. A certain type of update system function means a function of, for example, inputting, changing, and deleting information corresponding to the type. The terminal image P2 may further receive operation for executing a function other than the update system functions. The function other than the update system functions may be any function.

The button B15 is a button for displaying a user management image. When receiving selection operation on the button B15, the server 30 generates a user management image and displays the generated user management image. Here, the user management image is an image for receiving operation of, for example, inputting, changing, deleting, and displaying information concerning the user in the information stored in the server 30.

The button B16 is a button for receiving operation of causing the terminal device 40 to log out from the server 30. When receiving selection operation on the button B16, the server 30 causes the terminal device 40 to log out.

In the present embodiment, explanation is omitted about each of the dashboard image, the master data management image, the manual image, and the user management image.

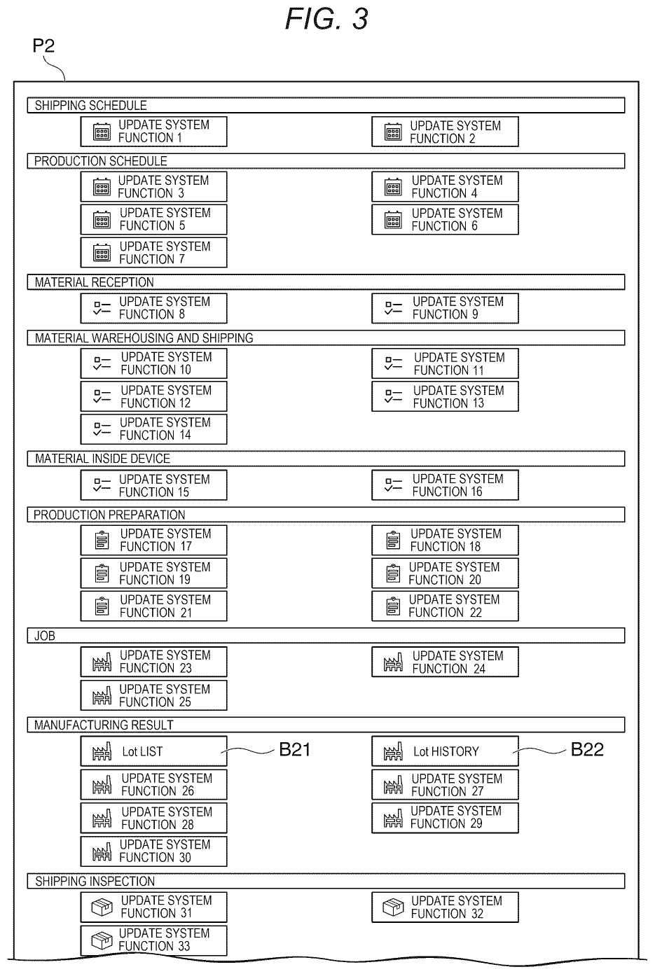

FIG. 3 is a diagram illustrating an example of the terminal image P2. As illustrated in FIG. 3, the terminal image P2 includes buttons for receiving operation of executing each of a plurality of update system functions. For example, the terminal image P2 includes a button B21 and a button B22 as such buttons.

The button B21 is a button for receiving operation of displaying a lot search image P3 that is an example of the lot search image explained above. When receiving selection operation on the button B21, the server 30 generates the lot search image P3 and displays the generated lot search image P3.

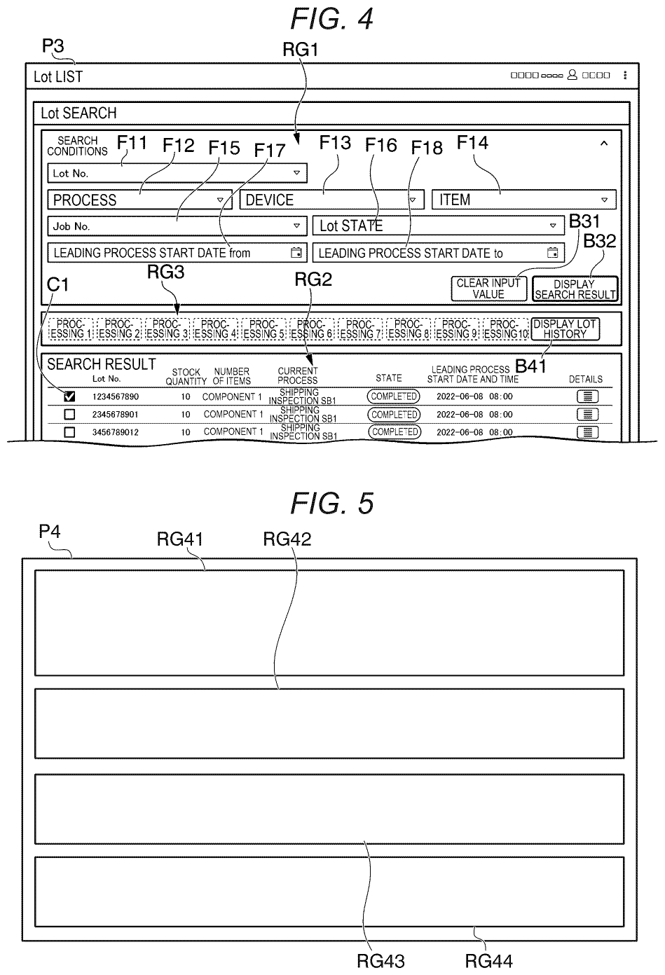

FIG. 4 is a diagram illustrating an example of the lot search image P3. In the example illustrated in FIG. 4, the lot search image P3 includes a lot search region RG1, a search result display region RG2, and a processing button group region RG3.

The lot search region RG1 includes, for example, each of an input field F11 to an input field F18, a button B31, and a button B32. The lot search region RG1 may include, instead of a part or all of these GUIs or in addition to all of these GUIs, another GUI capable of receiving operation of searching for a lot. Here, the lot search operation explained above means individual operation received at the lot search region RG1. In the molding management system 1, the search for a lot is a search for lot information.

The input field F11 is a field to which lot identification information for identifying a lot desired by the user is input. “Lot No.”, which is a character string superimposed on the input field F11 in FIG. 4, is a character string for indicating to the user that information input to the input field F11 is the lot identification information. In the example illustrated in FIG. 4, nothing is input to the input field F11. The input of the lot identification information to the input field F11 may be performed according to selection of the lot identification information by a pull-down menu or may be performed by direct input by an input device such as a keyboard.

The input field F12 is a field to which process information indicating a work process currently performed on a product of a lot desired by the user among various processes included in the production process. Therefore, in the example illustrated in FIG. 4, the lot related information includes the process information. The search for a lot can be performed using the process information as a search key. “Process”, which is a character string superimposed on the input field F12 in FIG. 4, is a character string for indicating to the user that information input to the input field F12 is the process information. In the example, nothing is input to the input field F12. The input of the process information to the input field F12 may be performed according to selection of the process information by a pull-down menu or may be performed by direct input by an input device such as a keyboard.

The input field F13 is a field to which injection molding device identification information for identifying an injection molding device that molded a product of a lot desired by the user or an injection molding device scheduled to mold the product of the lot desired by the user is input. Therefore, in the example illustrated in FIG. 4, the lot related information includes the injection molding device identification information. The search for a lot can be performed using the injection molding device identification information as a search key. “Device”, which is a character string superimposed on the input field F13 in FIG. 4, is a character string for indicating to the user that information input to the input field F13 is the injection molding device identification information. In the example, nothing is input to the input field F13. The input of the injection molding device identification information to the input field F13 may be performed according to selection of the injection molding device identification information by a pull-down menu or may be performed by direct input by an input device such as a keyboard.

The input field F14 is a field to which product type information indicating a type of a product of a lot desired by the user is input. Therefore, in the example illustrated in FIG. 4, the lot related information includes the product type information. The search for a lot can be performed using the product type information as a search key. “Item”, which is a character string superimposed on the input field F14 in FIG. 4, is a character string for indicating to the user that information input to the input field F14 is the product type information. In the example, nothing is input to the input field F14. The input of the product type information to the input field F14 may be performed according to selection of the product type information by a pull-down menu or may be performed by direct input by an input device such as a keyboard.

The input field F15 is a field to which information for identifying a higher-order group to which a lot desired by the user belongs is input. In the following explanation, as an example, a case in which the group is a manufacturing lot is explained. For this reason, in the following explanation, for convenience of explanation, the information is referred to as manufacturing lot identification information. Therefore, in the example illustrated in FIG. 4, the lot related information includes the manufacturing lot identification information. The search for a lot can be performed using the manufacturing lot identification information as a search key. The group may be another group such as a work shift of an administrator who manages production of a product of a lot. “Job No.”, which is a character string superimposed on the input field F15 in FIG. 4, is a character string for indicating to the user that information input to the input field F15 is the manufacturing lot identification information. In the example, nothing is input to the input field F15. The input of the manufacturing lot identification information to the input field F15 may be performed according to selection of the manufacturing lot identification information by a pull-down menu or may be performed by direct input by an input device such as a keyboard.

The input field F16 is a field to which lot state information indicating a state of a lot desired by the user is input. Therefore, in the example illustrated in FIG. 4, the lot related information includes the lot state information. The search for a lot can be performed using the lot state information as a search key. “Lot state”, which is a character string superimposed on the input field F16 in FIG. 4, is a character string for indicating to the user that information input to the input field F16 is the lot state information. In the example, nothing is input to the input field F16. The lot state information is, for example, information indicating any state such as a state in which a lot is stopped, a state in which a lot is being set out, a state in which a lot is on standby, or a state in which a lot is completed. In the following explanation, for convenience of explanation, the state in which a lot is stopped is simply referred to as lot stopped. In the following explanation, for convenience of explanation, the state in which a lot is being set out is simply referred to as lot set out. In the following explanation, for convenience of explanation, the state in which a lot is on standby state is simply referred to as lot on standby. In the following explanation, for convenience of explanation, the state in which a lot is completed is simply referred to as lot completed. The input of the lot state information to the input field F16 may be performed according to selection of the lot state information by a pull-down menu or may be performed by direct input by an input device such as a keyboard.

The input field F17 and the input field F18 are fields to which period information indicating a period including year, month, and day when production of a product of a lot desired by the user was started is input. Therefore, in the example illustrated in FIG. 4, the lot related information includes information indicating the year, month, and day. The search for a lot can be performed using the information as a search key. “Leading process start date from”, which is a character string superimposed on the input field F17 in FIG. 4, is a character string indicating to the user that information input to the input field F17 is start date and time information indicating a date and time when the period starts. “Leading process start date to”, which is a character string superimposed on the input field F18 in FIG. 4, is a character string indicating to the user that information input to the input field F18 is end date and time information indicating a date and time when the period ends. In the example, nothing is input to the input field F17 and the input field F18. The input of the start date and time information to the input field F17 may be performed according to selection of year, month and day by a calendar or the like, and selection of time by a timepiece or the like, or may be performed by direct input by an input device such as a keyboard. The input of the end date and time information to the input field F18 may be performed according to selection of year, month, and day by a calendar or the like, and selection of time by a timepiece or the like, or may be performed by direct input by an input device such as a keyboard. The start date and time information may be information indicating only year, month, and day. The end date and time information may be information indicating only year, month, and day.

The button B31 is a button for receiving operation of deleting respective pieces of information input to a part or all of the input field F11 to the input field F18. In other words, the button B31 is a button for receiving operation of clearing respective pieces of information input to a part or all of the input field F11 to the input field F18. When selection operation on the button B31 is performed, the server 30 deletes respective pieces of information input to a part or all of the input field F11 to the input field F18.

The button B32 is a button for receiving operation of executing a search for a lot based on respective pieces of information input to a part or all of the input field F11 to the input field F18. When selection operation on the button B32 is performed, the server 30 extracts one or more pieces of lot information including respective pieces of information input to a part or all of the input field F11 to the input field F18 out of one or more pieces of lot information stored in advance. After extracting one or more pieces of lot information, the server 30 displays a list of the extracted one or more pieces of lot information in the search result display region RG2. In the following explanation, for convenience of explanation, the list is simply referred to as lot information list.

The search result display region RG2 is a region where the lot information list is displayed as a result of the selection operation on the button B32 being performed. In the search result display region RG2, when the selection operation on the button B32 is not performed, a list of all pieces of lot information stored in the server 30 may be displayed or nothing may be displayed. In the example illustrated in FIG. 4, the list is displayed in the search result display region RG2. The number of pieces of lot information displayed in the search result display region RG2 may be determined in advance. In this case, a button for displaying the lot information that could not be displayed in the search result display region RG2 is included in the search result display region RG2.

In the example illustrated in FIG. 4, the lot information displayed in the search result display region RG2 includes a part of the lot related information together with the lot identification information. Specifically, the lot information includes each of the lot identification information, the number of products information, the product type information, the process information, the lot state information, and the start date and time information. The lot information may include all pieces of the lot related information together with the lot identification information. For example, lot information displayed at the top part of the search result display region RG2 illustrated in FIG. 4 includes “1234567890” as the lot identification information, includes “10” as the number of products information, includes “component 1” as the product type information, includes “shipping inspection SB1” as the process information, includes lot state information indicating lot completed, and includes “2022-06-08 08:00” as the start date and time information. Here, the “10” is the number of products information indicating ten products. The “2022-06-08 08:00” is start date and time information indicating 08:00 on Jun. 8, 2022.

In respective pieces of lot information displayed in the search result display region RG2, a not-illustrated detailed display button is incidentally displayed. A detailed display button displayed incidental to certain lot information is a button for receiving operation of displaying a detailed information display image in which detailed information of a lot indicated by the lot information is displayed. The detailed information displayed in the detailed information display image includes at least a part of information displayed in the search result display region RG2 in information included in the lot information and at least a part of information not displayed in the search result display region RG2 in the information included in the lot information.

Here, as described above, one or more pieces of information included in lot related information of certain lot information are associated with lot identification information included in the lot information. For this reason, the server 30 can extract the lot information from a storage area of the server 30 using the lot identification information. This not only leads to simplification of a data structure of lot information but also leads to reducing a load of search processing for a lot by the server 30 and is useful.

In the search result display region RG2, when one or more pieces of lot information are displayed, a check box for receiving operation of selecting each of the one or more pieces of lot information is displayed. For example, the check box C1 illustrated in FIG. 4 is a check box for receiving operation of selecting the lot information displayed at the top part of the search result display region RG2. In the search result display region RG2, a checkbox for receiving operation of selecting all pieces of lot information displayed in the search result display region RG2 may be displayed. Accordingly, the server 30 can reduce time and effort required for selection of lot information by the user. In the following explanation, for convenience of explanation, such operation of selecting lot information via the check box is referred to as lot information selection operation. Selection of certain lot information may be referred to as selection of a lot indicated by the lot information.

The processing button group region RG3 is a region where a GUI for receiving processing execution operation of causing the server 30 to start executing predetermined processing on a lot indicated by each of one or more pieces of lot information selected according to received lot information selection operation among one or more pieces of lot information displayed in the search result display region RG2 is displayed. In the example illustrated in FIG. 4, eleven buttons are displayed in the processing button group region RG3 as such a GUI. In the example, the eleven buttons include a button B41. In the present embodiment, explanation is omitted about buttons other than the button B41 among the eleven buttons.

The button B41 is a button for setting, as a target lot, the lot selected by the user in the search result display region RG2 and receiving operation of displaying a history information display image for displaying history information included in lot related information of lot information indicating the target lot. When a predetermined first gray-out condition is satisfied, the server 30 grays out the button B41 and does not receive selection operation on the button B41. On the other hand, when the first gray-out condition is not satisfied, the server 30 releases the gray-out of the button B41 and receives the selection operation on the button B41. According to such gray-out, the server 30 can suppress erroneous operation by the user. The first gray-out condition is, for example, a condition including two conditions of the following conditions 1A and 1B
Condition 1A: a plurality of lots are selected by the user in the search result display region RG2
Condition 1B: no lot is selected by the user in the search result display region RG2

When one of the condition 1A and the condition 1B is satisfied, the server 30 determines that the first gray-out condition is satisfied. On the other hand, when both of the condition 1A and the condition 1B are not satisfied, the server 30 determines that the first gray-out condition is not satisfied.

Here, in the example illustrated in FIG. 4, among the plurality of lots displayed in the search result display region RG2, a lot displayed at the top part is selected by the user and the other lots are not selected. For this reason, in the example, the button B41 is not grayed out. The button B41 is an example of a second history information display image display operation reception image.

When the selection operation on the button B41 is performed, the server 30 specifies, as a target lot, the lot selected by the user in the search result display region RG2 and displays the history information display image P4 for displaying the history information included in lot related information of lot information indicating the target lot.

FIG. 5 is a diagram illustrating an example of an overall image of the history information display image P4 displayed when the selection operation on the button B41 illustrated in FIG. 4 is performed. In the example illustrated in FIG. 5, the history information display image P4 includes four regions of a display region RG41 to a display region RG44. The server 30 may be configured to display the history information display image P4 as one of images included in the lot search image P3, may be configured to display the history information display image P4 in another window, may be configured to display the history information display image P4 to be superimposed on the lot search image P3, may be configured to display the history information display image P4 as popup, or may be configured to display the history information display image P4 with another method.

In the example illustrated in FIG. 5, the display region RG41 to the display region RG44 are arranged in the order of the display region RG41, the display region RG42, the display region RG43, and the display region RG44 from the top to the bottom in FIG. 5. The display region RG41 to the display region RG44 may be arranged in another order, may be arranged in another direction, or may be arranged in another format.

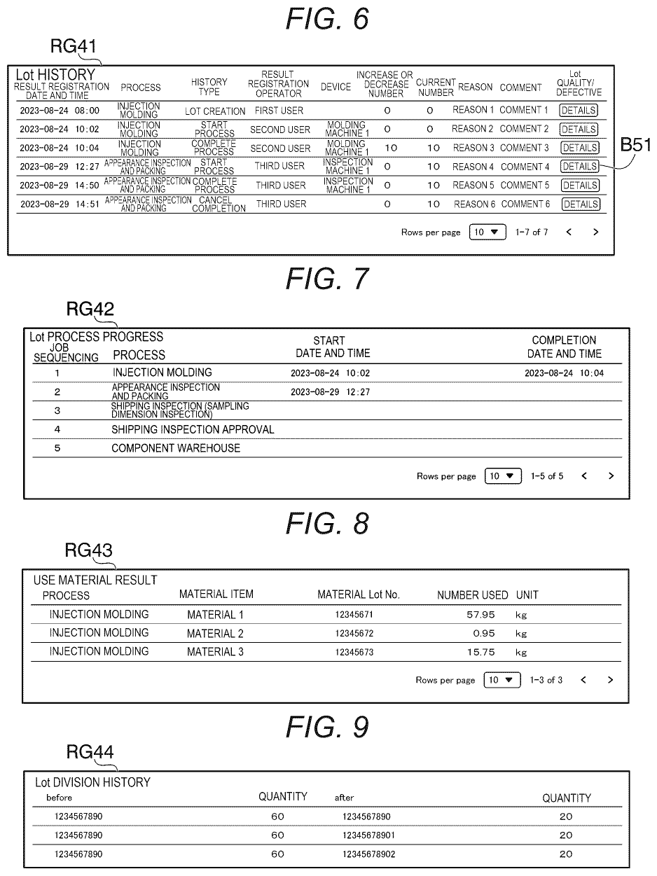

FIG. 6 is an enlarged view of the display region RG41 illustrated in FIG. 5. The display region RG41 is a region where lot information change history information among various information included, as the history information, in the lot related information of the lot information indicating the target lot is displayed. As explained above, the lot information change history information means information indicating a history concerning a change of the lot information indicating the target lot. In other words, the lot information change history information means information indicating a history concerning a change by the user for at least one piece of information included in the lot information indicating the target lot. For example, when a change by the user is performed on information X included in the lot information indicating the target lot, the lot information change history information indicates a history concerning the change of the information X performed by the user. The information X may be any information if the information is information included in the lot information indicating the target lot.

In the example illustrated in FIG. 6, the lot information change history information displayed in the display region RG41 includes lot information change date and time information, process information change history information, history type information, lot information changer information, device information, number of changed number of products history information, number of products history information, lot information change reason information, and lot information change comment information. That is, in the example, the history information of the lot information indicating the target lot includes, as the lot information change history information, each of the lot information change date and time information, the process information change history information, the history type information, the lot information changer information, the device information, the number of changed number of products history information, the number of products history information, the lot information change reason information, and the lot information change comment information. The lot information change history information displayed in the display region RG41 may include, instead of a part or all of these kinds of information or in addition to all of these kinds of information, other information indicating a history concerning a change of the lot information indicating the target lot. Here, lot information change date and time information included in certain lot information change history information is information indicating a date and time when lot information including the lot information change history information is changed. The process information change history information included in the lot information change history information is information indicating a history of a change of the process information at a date and time indicated by the lot information change date and time information. The process information change history information may be, for example, process information included in the lot information at the date and time or may be other information indicating a history of a change of process information at the date and time. The history type information included in the lot information change history information is information indicating a type of a change of the lot information performed by the user. The lot information changer information included in the lot information change history information is information indicating a user who changed the lot information at the date and time. The device information included in the lot information change history information is information indicating a device that performed work on a product of the target lot at the date and time. The device information may be null information when there is no device that performed work on the product of the target lot at the date and time or may be another information indicating that there is no device that performed work on the product of the target lot at the date and time. The number of changed number of products history information included in the lot information change history information is information indicating a difference in a number indicated by the number of products information before and after the change in the change of the number of products information of the lot information at the date and time. The number of changed number of products history information may be represented by a positive or negative integer or may be the number of products information at the date and time. However, when the number of changed number of products history information is the number of products information, the number indicated by the number of changed number of products history information coincides the number indicated by the number of products history information. The number of products history information included in the lot information change history information is information indicating a history of a change of the number of products information of the lot information at the date and time. The number of products history information may be, for example, number of products information included in the lot information at the date and time or may be other information indicating a history of a change of the number of products information at the date and time. The lot information change reason information included in the lot information change history information is information indicating a reason why the lot information was changed at the date and time. The lot information change comment information included in the lot information change history information is information indicating a comment about the change of the lot information at the date and time.

In the display region RG41 illustrated in FIG. 6, the lot information change date and time information is indicated by “result registration date and time.” In the display region RG41 illustrated in FIG. 6, the process information change history information is indicated by “process.” In the display region RG41 illustrated in FIG. 6, the history type information is indicated by “history type.” In the display region RG41 illustrated in FIG. 6, the lot information changer information is indicated by “result registration operator.” In the display region RG41 illustrated in FIG. 6, the device information is indicated by “device.” In the display region RG41 illustrated in FIG. 6, the number of changed number of products history information is indicated by “increase or decrease number.” In the display region RG41 illustrated in FIG. 6, the number of products history information is indicated by “current number.” In the display region RG41 illustrated in FIG. 6, the lot information change reason information is indicated by “reason.” In the display region RG41 illustrated in FIG. 6, the lot information change comment information is indicated by “comment.”

For example, lot information change history information displayed in the top part of the display region RG41 illustrated in FIG. 6 includes “2023-08-24 08:00” as the lot information change date and time information, includes “injection molding” as the process information change history information, includes “lot creation” as the history type information, includes “first user” as the lot information changer information, includes null information as the device information, includes “0” as the number of changed number of products history information, includes “0” as the number of products history information, includes “reason 1” as the lot information change reason information, and includes “comment 1” as the lot information change comment information. Here, the “2023-08-24 08:00” indicates 08:00 on Aug. 24, 2023. The “injection molding” is also process information included in lot information indicating a target lot at 08:00 on Aug. 24, 2023 and indicates that a work process performed on a product of the target lot at 08:00 on Aug. 24, 2023 is an injection molding process. The “lot creation” indicates that the lot information has been generated as one of changes of the lot information indicating the target lot. The “first user” indicates that a user who changed the lot information is the first user. The null information serving as the device information in the lot information change history information indicates that there was no device that performed work on a product of a lot indicated by the lot information at 08:00 on Aug. 24, 2023. The “0” serving as the number of changed number of products history information in the lot information change history information indicates that number of products information included in the lot information was not changed in the change of the lot information at 08:00 on Aug. 24, 2023. The “0” serving as the number of products history information in the lot information change history information indicates that the number of products information included in the lot information was not changed in the change of the lot information at 08:00 on Aug. 24, 2023. The “reason 1” indicates a reason why the lot information was changed at 08:00 on Aug. 24, 2023. The “comment 1” indicates a comment by the first user about the change of the lot information at 08:00 on Aug. 24, 2023.

As explained above, the lot information change history information included in the lot information indicating the target lot is displayed in the display region RG41. For example, when the lot information change history information displayed in the top part of the display region RG41 illustrated in FIG. 6 and lot information change history information displayed in the second part from the top of the display region RG41 illustrated in FIG. 6 are compared, it is possible to read that, at 10:02 on Aug. 24, 2023, a state in which the injection molding process on the product of the target lot was not started changed to a state in which the injection molding process was started. This can be read from the fact that the history type information is different when these two pieces of lot information change history information are compared. For example, when the lot information change history information displayed in the second part from the top of the display region RG41 illustrated in FIG. 6 and lot information change history information displayed in the third part from the top of the display region RG41 illustrated in FIG. 6 are compared, it is possible to read that, at 10:04 on Aug. 24, 2023, the state in which the injection molding process on the product of the target lot was started changed to a state in which the injection molding process was completed. For this reason, in the lot information change history information displayed in the third part from the top of the display region RG41 illustrated in FIG. 6, the number of changed number of products history information is “10” indicating+10 products and the number of products history information is “10” indicating 10 products. That is, in the example illustrated in FIG. 6, it is possible to read, by viewing the display region RG4, that ten products of the target lot was molded by the injection molding process in two minutes from 10:02 on Aug. 24, 2023 to 10:04 on Aug. 24, 2023. For example, when the lot information change history information displayed in the third part from the top of the display region RG41 illustrated in FIG. 6 and lot information change history information displayed in the fourth part from the top of the display region RG41 illustrated in FIG. 6 are compared, it is possible to read that, at 12:27 on Aug. 29, 2023, the work process on the product of the target lot changed from the injection molding process to an appearance inspection and packing process and a state in which the appearance inspection and packing process was not started changed to a state in which the appearance inspection and packing process was started. For this reason, in the lot information change history information displayed in the fourth part from the top of the display region RG41 illustrated in FIG. 6, the device information is “inspection machine 1” indicating an inspection device. In the example illustrated in FIG. 6, it is possible to read, by looking at the display region RG41, that the number of products of the target lot was not changed in a period from 10:04 on Aug. 24, 2023 to 12:27 on Aug. 29, 2023. As explained above, by displaying the lot information change history information, the server 30 can cause the user to easily specify the date and time when, the work process in which, the reason why, the comment on, and the like, for example, the number of products of the target lot was changed. That is, the server 30 can improve traceability for a molded product by displaying the lot information change history information.

In the display region RG41, editing of the lot information change reason information, the lot information change comment information, and the like by the user can be performed. In this case, for example, the input of the lot information change reason information to the display region RG41 may be performed according to selection of the lot information change reason information by a pull-down menu or may be directly performed by an input device such as a keyboard. In this case, for example, the input of the lot information change comment information to the display region RG41 may be performed according to selection of the lot information change comment information by a pull-down menu or may be directly performed by an input device such as a keyboard.

In the display region RG41, a button for receiving operation of displaying a quality inspection history information display image is displayed incidentally to respective pieces of lot information change reason information. Here, the quality inspection history information display image means an image for displaying quality inspection history information. For example, a button displayed incidentally to certain lot information change history information is a button for receiving operation of displaying a quality inspection history information display image for displaying quality inspection history information included in history information including the lot information change history information. For example, the quality inspection history information display image is an image for displaying, as quality inspection history information, quality information of the target lot at a date and time indicated by lot information change date and time information included in the lot information change history information. The quality information of the target lot means quality information included in the lot information indicating the target lot. In this case, the lot information includes one or more pieces of quality information including a time stamp indicating a date and time when the lot information was generated. The button B51 illustrated in FIG. 5 is an example of the button for receiving the operation. In other words, the button B51 is an example of a quality inspection history information display operation reception image. The operation is an example of quality inspection history information display operation. The quality inspection history information display image is explained below. However, when receiving selection operation on the button B51, the server 30 generates a quality inspection history information display image for displaying quality inspection history information included in history information including lot information change reason information to which the button B51 is incidental and displays the generated quality inspection history information display image. The quality inspection history information display image may be an image for displaying, as the quality inspection history information, other information indicating a history concerning inspection of the quality of the product of the target lot.

FIG. 7 is an enlarged view of the display region RG42 illustrated in FIG. 5. The display region RG42 is a region where work process change history information among various information included, as history information, in the lot related information of the lot information indicating the target lot is displayed. As explained above, the work process change history information means information indicating a history concerning a change of a work process performed on the product of the target lot.

In the example illustrated in FIG. 7, the work process change history information displayed in the display region RG42 includes process information, job sequencing information, process start date and time information, and process end date and time information. That is, in the example, the history information of the lot information indicating the target lot includes each of the process information, the job sequencing information, the process start date and time information, and the process end date and time information as the work process change history information. The work process change history information displayed in the display region RG42 may include, instead of a part or all of these kinds of information or in addition to all of these kinds of information, other information indicating a history concerning a change of a work process performed on the product of the target lot. Here, process information included in certain work process change history information is information indicating a work process started at a date and time indicated by process start date and time information included in the work process change history information among work processes performed on the product of the target lot. In this case, the display region RG42 indicates that the work process performed on the product of the target lot has been changed by a change of the process information in a list of process information displayed in the display region RG42. The job sequencing information included in the work process change history information is information indicating, as order of a work process in a plurality of work processes performed on the product of the target lot, order of the work processes started at the date and time indicated by the process start date and time information included in the work process change history information. In this case, the display region RG42 indicates, according to a way of a change of the job sequencing information in the list of the job sequencing information displayed in the display region RG42, whether the work process performed on the product of the target lot is performed as indicated by job sequencing. The process start date and time information included in the work process change history information is information indicating a date and time when the work process indicated by the process information included in the work process change history information was started. The display region RG42 indicates, according to presence or absence of the process start date and time information, whether the work process performed on the product of the target lot has been started. The process end date and time information included in the work process change history information is information indicating a date and time when the work process indicated by the process information included in the work process change history information was ended. The display region RG42 indicates, according to presence or absence of the process end date and time information, whether the work process performed on the product of the target lot has been ended.

In the display region RG42 illustrated in FIG. 7, the process information is indicated by “process.” In the display region RG42 illustrated in FIG. 7, the job sequencing information is indicated by “job sequencing.” In the display region RG42 illustrated in FIG. 7, the process start date and time information is indicated by “start date and time.” In the display region RG42 illustrated in FIG. 7, the process end date and time information is indicated by “completion date and time.”

For example, work process change history information displayed in the top part of the display region RG42 illustrated in FIG. 7 includes “injection molding” as the process information, “1” as the job sequencing information, “2023-08-24 10:02” as the process start date and time information, and “2023-08-24 10:04” as the process end date and time information. Here, the “injection molding” indicates an injection molding process of molding the product of the target lot. The “1” indicates that job sequencing of the injection molding process is the first. The “2023-08-24 10:02” indicates that a date and time when the injection molding process was started is 10:02 on Aug. 24, 2023. The “2023-08-24 10:04” indicates that a date and time when the injection molding process was ended is 10:04 on Aug. 24, 2023.

As explained above, the work process change history information included in the lot information indicating the target lot is displayed in the display region RG42. Then, for example, when the work process change history information displayed in the uppermost portion of the display region RG42 illustrated in FIG. 7 and work process change history information displayed in the second part from the top of the display region RG42 illustrated in FIG. 7 are compared, it is possible to read that the injection molding process on the product of the target lot ended at 10:04 on Aug. 24, 2023 and the appearance inspection and packing process on the product of the target lot was started on 12:27 on Aug. 29, 2023. For example, when work process change history information displayed in the third and subsequent parts from the top of the display region RG42 illustrated in FIG. 7 is viewed, it is possible to read that each of a shipment inspection (sampling dimension inspection) process, a shipping inspection approval process, and a component warehouse carry-in process on the product of the target lot has not been carried out yet. As explained above, by displaying the work process change history information, the server 30 can cause the user to easily specify, for example, the date and time when the work process performed on the product of the target lot was changed. That is, the server 30 can improve traceability about a molded product by displaying the work process change history information.

FIG. 8 is an enlarged view of the display region RG43 illustrated in FIG. 5. The display region RG43 is a region where material history information among various information included, as history information, in the lot related information of the lot information indicating the target lot is displayed. As explained above, the material history information is information indicating a history concerning use of a material of the product of the target lot.

In the example illustrated in FIG. 8, the material history information displayed in the display region RG43 includes process information, material type information, material lot identification information, material use amount information, and material use amount unit information. That is, in the example, the history information of the lot information indicating the target lot includes, as the material history information, each of the process information, the material type information, the material lot identification information, the material use amount information, and the material use amount unit information. The material history information displayed in the display region RG43 may include, instead of a part or all of these kinds of information or in addition to all of these kinds of information, other information indicating a history concerning use of the material of the product of the target lot. Here, process information included in certain material history information is information indicating a work process using the material of the product among a plurality of work processes performed on the product of the target lot. The material type information included in the material history information is information indicating a type of the material used in the work process. The material lot identification information included in the material history information is material lot identification information allocated to the material. The material use amount information included in the material history information is information indicating an amount of the material used in the work process. The material use amount unit information included in the material history information is information indicating a unit of the amount of the material used in the work process.

In the display region RG43 illustrated in FIG. 8, the process information is indicated by “process.” In the display region RG43 illustrated in FIG. 8, the material type information is indicated by “material item.” In the display region RG43 illustrated in FIG. 8, the material lot identification information is indicated by “material Lot No . . . ” In the display region RG43 illustrated in FIG. 8, the material use amount information is indicated by “number used.” In the display region RG43 illustrated in FIG. 8, the material use amount unit information is indicated by “unit.”

For example, the material history information displayed in the top part of the display region RG43 illustrated in FIG. 8 includes “injection molding” as the process information, includes “material 1” as the material type information, includes “12345671” as the material lot identification information, includes “57.95” as the material use amount information, and includes “kg” as the material use amount unit information. Here, the “injection molding” indicates an injection molding process of molding the product of the target lot. The “material 1” indicates that the type of the material used in the molding process is a material 1. The material use amount information and the material use amount unit information may be integrated into one piece of information.

As explained above, the material history information included in the lot information indicating the target lot is displayed in the display region RG43. For example, when viewing the list of the material history information displayed in the display region RG43 illustrated in FIG. 8, the user can easily specify a work process in which the material is used among work processes performed on the product of the target lot and easily specify a material lot of the used material. This makes it possible to easily specify the presence or absence of a material used in an application that is not intended by an administrator or the like, a work process in which a material having a problem is used, a lot, and the like. That is, the server 30 can improve traceability about a molded product by displaying the material history information.

FIG. 9 is an enlarged view of the display region RG44 illustrated in FIG. 5. The display region RG44 is a region where lot management history information among various information included, as history information, in the lot related information of lot information indicating the target lot is displayed. As explained above, the lot management history information is information indicating a history concerning management of the target lot.

Here, the management of the target lot means, for example, division of the target lot into a plurality of lots, a change of the number of products of the target lot, movement of a product between the target lot and another lot, coupling of another lot to the target lot, and the like but is not limited to these. These kinds of management of the target lot may be performed by any method. In the following explanation, in order to simplify the explanation, a case in which the management of the target lot is only the division of the target lot into a plurality of lots is explained as an example. In this case, the lot management history information may be referred to as lot division history information indicating a history concerning the division of the target lot. Thus, in the following explanation, for convenience of explanation, the lot management history information is referred to as lot division history information.

In the example illustrated in FIG. 9, the lot division history information displayed in the display region RG44 includes lot identification information for identifying the target lot before being divided, number of products information indicating the number of products of the target lot before being divided, lot identification information indicating any one of lots after the target lot is divided, and number of products information indicating the number of products of the lot indicated by the lot identification information. That is, in the example, the history information of the lot information indicating the target lot includes, as the lot division history information, each of the number of products information indicating the number of products of the target lot before being divided, the lot identification information indicating any one of lots after the target lot is divided, and the number of products information indicating the number of products of the lot indicated by the lot identification information. The lot division history information displayed in the display region RG44 may include, instead of a part or all of these kinds of information or in addition to all of these kinds of information, other information indicating a history concerning the management of the target lot.

In the display region RG44 illustrated in FIG. 9, lot identification information for identifying the target lot before being divided is indicated by “before.” In the following explanation, for convenience of explanation, the lot identification information is referred to as division source lot identification information. In the display region RG44 illustrated in FIG. 9, the number of products information indicating the number of products of the target lot before being divided is indicated by “quantity” located on the right of “before.” In the following explanation, for convenience of explanation, the number of products information is referred to as the division source number of products information. In the display region RG44 illustrated in FIG. 9, lot identification information indicating any one of the lots after the target lot is divided is indicated by “after.” In the following explanation, for convenience of explanation, the lot identification information is referred to as division destination lot identification information. In the display region RG44 illustrated in FIG. 9, the number of products information indicating the number of products of the lot indicated by the division destination lot identification information is indicated by “quantity” located on the right of “after.” In the following explanation, for convenience of explanation, the number of products information is referred to as division destination number of products information.

For example, lot division history information displayed in the top part of the display region RG44 illustrated in FIG. 9 includes “1234567890” as the division source lot identification information, includes “60” as the division source number of products information, includes “1234567890” as the division destination lot identification information, and includes “20” as the division destination number of products information. Here, the “60” indicates that the number indicated by the division source number of products information is sixty. Here, the “20” indicates that the number indicated by the division destination number of products information is twenty.

In the display region RG44 illustrated in FIG. 9, a list of three pieces of lot division history information is displayed. This indicates that the target lot indicated by the division source lot identification information is divided into three lots. The division destination lot identification information displayed in the top part of the display region RG44 being the division source lot identification information means that lot identification information of any one of the three lots is matched with the lot identification information of the target lot in the server 30. However, in the server 30, this is merely an example and the lot identification information of each of the three lots may be lot identification information different from the division source lot identification information. The server 30 may use any method as a method of generating lot identification information of each of the three lots.

As explained above, the lot division history information included in the lot information indicating the target lot is displayed in the display region RG44. For example, when viewing the list of the lot division history information displayed in the display region RG44 illustrated in FIG. 9, the user can easily specify the lot identification information of each of the three lots after the target lot is divided. This can make it easy to specify a relation among lots after division of a lot, which is an example of the management of the lot. That is, the server 30 can improve traceability about a molded product by displaying the material history information.

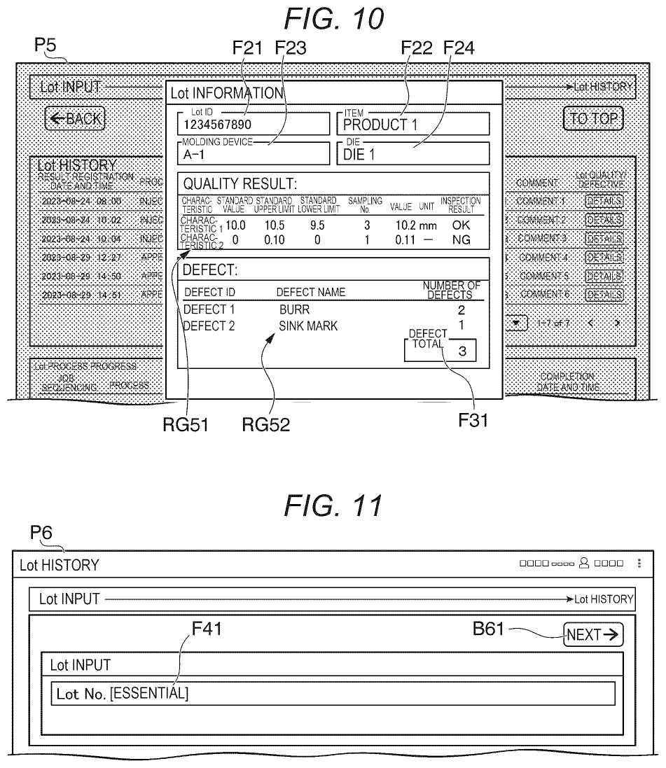

FIG. 10 is a diagram illustrating an example of the quality inspection history information display image P5 displayed by the server 30 when selection operation on the button B51 illustrated in FIG. 5 is performed. The server 30 may be configured to display the quality inspection history information display image P5 as one of the images included in the history information display image P4, may be configured to display the quality inspection history information display image P5 in another window, may be configured to display the quality inspection history information display image P5 to be superimposed on the history information display image P4, may be configured to display the quality inspection history information display image P5 as popup, or may be configured to display the quality inspection history information display image P5 with another method. In the example illustrated in FIG. 10, the quality inspection history information display image P5 is displayed as popup on the history information display image P4.

In the example illustrated in FIG. 10, the quality inspection history information display image P5 includes each of display fields F21 to F24, a display region RG51, and a display region RG52. The quality inspection history information display image P5 may include, instead of a part or all of these GUIs or in addition to all of these GUIs, other GUIs concerning the display of the quality inspection history information.

The display field F21 is a field in which the lot identification information included in the lot information indicating the target lot is displayed. “Lot ID”, which is a character string superimposed on the display field F21 in FIG. 10, is a character string for indicating to the user that information displayed in the display field F21 is the lot identification information. In the example illustrated in FIG. 10, “1234567890” is displayed in the display field F21 as the lot identification information.

The display field F22 is a field in which the product type information included in the lot information indicating the target lot is displayed. “Item”, which is a character string superimposed on the display field F22 in FIG. 10, is a character string for indicating to the user that information displayed in the display field F22 is the product type information. In the example illustrated in FIG. 10, “product 1” is displayed in the display field F22 as the product type information.

The display field F23 is a field in which the injection molding device identification information included in the lot information indicating the target lot is displayed. “Molding device”, which is a character string superimposed on the display field F23 in FIG. 10, is a character string for indicating to the user that information displayed in the display field F23 is the injection molding device identification information. In the example illustrated in FIG. 10, “A-1” is displayed in the display field F23 as the injection molding device identification information.

The display field F24 is a field in which the die identification information included in the lot information indicating the target lot is displayed. “Die”, which is a character string superimposed on the display field F24 in FIG. 10, is a character string for indicating to the user that information displayed in the display field F24 is the die identification information. In the example illustrated in FIG. 10, “die 1” is displayed in the display field F24 as the die identification information.

Here, the quality inspection history information display image P5 is an image in which the quality inspection history information is displayed as explained above. In the example illustrated in FIG. 10, in the quality inspection history information display image P5, in addition to the quality inspection history information being displayed, defective product occurrence history information is displayed. In the quality inspection history information display image P5, the display region R51 is a region where the quality inspection history information is displayed. In the quality inspection history information display image P5, the display region R52 is a region where the defective product occurrence history information is displayed.

In the example illustrated in FIG. 10, the quality inspection history information displayed in the quality inspection history information display image P5 means quality information of the target lot at the date and time indicated by the lot information change date and time information included in the lot information change history information displayed incidentally to the button B51. In the example, the quality inspection history information, that is, the quality information includes inspection item information indicating a type of an item inspected as the quality of the product of the target lot, reference value information serving as a reference for comparing an inspection result of the item indicated by the inspection item information, upper limit value information indicating an upper limit value of a predetermined range including a value indicated by the reference value information, lower limit value information indicating a lower limit value of the predetermined range, inspection number information indicating the number of products subjected to the inspection of the item, inspection value information indicating an average value of the inspection result of the item, inspection value unit information indicating a unit of the average value, and inspection result information indicating whether the inspection result of the item indicates a non-defective product. That is, in the example, the history information of the lot information indicating the target lot includes each of the inspection item information, the reference value information, the upper limit value information, the lower limit value information, the inspection number information, the inspection value information, the inspection value unit information, and the inspection result information as quality inspection result information change history information of quality information change history information. The predetermined range means a range including a value obtained as an inspection result when an inspection of the item is performed for a non-defective product. The quality inspection history information displayed in the display region RG51 may include, instead of a part or all of these kinds of information or in addition to all of these kinds of information, other information indicating a history concerning inspection of the quality of the product of the target lot. The quality inspection history information displayed in the quality inspection history information display image P5 may be information different from the quality information of the target lot at the date and time indicated by the lot information change date and time information included in the lot information change history information displayed incidentally to the button B51 if the information is information capable of indicating a history concerning inspection of the quality of the product of the target lot at the date and time indicated by the lot information change date and time information included in the lot information change history information displayed incidentally to the button B51.

In the display region RG51 illustrated in FIG. 10, the inspection item information is indicated by “characteristic.” In the display region RG51 illustrated in FIG. 10, the reference value information is indicated by “standard value.” In the display region RG51 illustrated in FIG. 10, the upper limit value information is indicated by “standard upper limit.” In the display region RG51 illustrated in FIG. 10, the lower limit value information is indicated by “standard lower limit.” In the display region RG51 illustrated in FIG. 10, the inspection number information is indicated by “sampling No . . . ” In the display region RG51 illustrated in FIG. 10, the inspection value information is indicated by “value.” In the display region RG51 illustrated in FIG. 10, the inspection value unit information is indicated by “unit.” In the display region RG51 illustrated in FIG. 10, the inspection result information is indicated by “inspection result.”

For example, the quality inspection history information displayed in the top part of the display region RG51 illustrated in FIG. 10 includes “characteristic 1” as the inspection item information, includes “10.0” as the reference value information, includes “10.5” as the upper limit value information, includes “9.5” as the lower limit value information, includes “3” as the inspection number information, includes “10.2” as the inspection value information, includes “mm” as the inspection value unit information, and includes “OK” as the inspection result information. Here, the “characteristic 1” indicates that a type of an item inspected as the quality of the product of the target lot is the characteristic 1. The “10.0” indicates that the value indicated by the reference value information is 10.0. The “10.5” indicates that the value indicated by the upper limit value information is 10.5. The “9.5” indicates that the value indicated by the lower limit value information is 9.5. The “3” indicates that the number indicated by the inspection number information is three. The “10.2” indicates that the value indicated by the inspection value information is 10.2. The “mm” indicates that the unit indicated by the inspection value unit information is millimeter. The “OK” indicates that the inspection result indicated by the inspection result information is a non-defective product.

As explained above, the quality inspection history information included in the lot information indicating the target lot is displayed in the display region RG51. For example, by comparing individual quality inspection history information display images that can be displayed from the display region RG41 illustrated in FIG. 6, the user can easily specify, for example, a date and time when, a work process in which, an inspection item for which the quality information indicating the quality of the product of the target lot changed. This is important because it is possible to make work relating to the quality management easy and make it easy to specify a cause of quality deterioration in the case in which the quality of the product of the target lot is deteriorated. That is, it can be said that this improves traceability about the product of the target lot. As explained above, the server 30 can improve traceability about a molded product by displaying the quality inspection history information display image like the quality inspection history information display image P5 illustrated in FIG. 10.

The defective product occurrence history information displayed in the display region RG52 means information indicating a history concerning occurrence of defective products in the inspection of the quality of the product of the target lot. In the example illustrated in FIG. 10, the defective product occurrence history information displayed in the quality inspection history information display image P5 means information including number of defective products information indicating the number of defective products included in the product of the target lot at the date and time indicated by the lot information change date and time information included in the lot information change history information displayed incidentally to the button B51. In the example, the defective product occurrence history information includes defect reason type identification information for identifying a type of a reason why a defective product included in the product of the target lot is determined as a defective product, defect reason information indicating the reason, and the number of defective products information. That is, in the example, the history information of the lot information indicating the target lot includes each of the defect reason type identification information, the defect reason information, and the number of defective products information as the defective product occurrence history information of the quality information change history information. The defective product occurrence history information displayed in the display region RG52 may include, instead of a part or all of these kinds of information or in addition to all of these kinds of information, other information indicating a history concerning occurrence of defective products in the inspection of the quality of the product of the target lot.

In the display region RG52 illustrated in FIG. 10, the defect reason type identification information is indicated by “defect ID.” In the display region RG52 illustrated in FIG. 10, the defect reason information is indicated by “defect name.” In the display region RG52 illustrated in FIG. 10, the number of defective products information is indicated by “number of defects.”

For example, defective product occurrence history information displayed in the top part of the display region RG52 illustrated in FIG. 10 includes “defect 1” as the defect reason type identification information, includes “burr” as the defect reason information, and includes “2” as the number of defective products information. Here, the “defect 1” indicates that the defect reason type identification information for identifying a type of a reason why a defective product included in the product of the target lot is determined as a defective product is the defect 1. The “burr” indicates that the reason is a burr being formed on the outer periphery of the product. The “2” indicates that the number of defective products due to the reason is two.

As explained above, the defective product occurrence history information is displayed in the display region RG52. For example, by comparing individual quality inspection history information display images that can be displayed from the display region RG41 illustrated in FIG. 6, the user can easily specify, for example, a date and time when, a work process in which, and an inspection item for which the number of defective products included in the product of the target lot changed. This is also important because it is possible to make work relating to the quality management easy and make it easy to specify a cause of quality deterioration in the case in which the quality of the product of the target lot is deteriorated. That is, it can be said that this improves traceability about the product of the target lot. As explained above, the server 30 can improve traceability about a molded product by displaying the quality inspection history information display image like the quality inspection history information display image P5 illustrated in FIG. 10.

In the present embodiment, since the defective product occurrence history information is displayed in the display region RG52, the lot information indicating the target lot includes the defective product occurrence history information. Here, in the server 30, the defective product occurrence history information may be treated as one piece of information together with the quality inspection history information. That is, when the quality information is treated as the quality inspection history information as illustrated in FIG. 10, the defective product occurrence history information may be treated as one piece of information together with the quality information.

As illustrated in FIG. 10, the display region RG52 may include a display field F31. The display field F31 is a field in which a total of numbers indicated by number of defective products information included in respective pieces of defective product occurrence history information displayed in the display region RG52 is displayed. Therefore, in FIG. 10, “3” indicating three products is displayed in the display field F31. The display region RG52 may not include the display field F31.

Referring back to FIG. 3, the button B22 is a button for receiving operation of displaying a history information display operation reception image P6. The history information display operation reception image P6 is an image for receiving operation of displaying the history information display image P4 using the lot identification information of the target lot. When selection operation on the button B22 is received, the server 30 generates the history information display operation reception image P6 and displays the generated history information display operation reception image P6. The button B22 is an example of a first history information display image display operation reception image. The history information display operation reception image P6 is an example of an image for receiving operation of displaying the history information display image.

FIG. 11 is a diagram illustrating an example of the history information display operation reception image P6. In the example illustrated in FIG. 11, the history information display operation reception image P6 includes, for example, an input field F41 and a button B61. The history information display operation reception image P6 may include other GUIs instead of one or both of the input field F41 and the button B61 or in addition to both of the input field F41 and the button B61.

The input field F41 is a field to which lot identification information for identifying a lot designated by the user as a target lot is input. “Lot No.”, which is a character string superimposed on the input field F41 in FIG. 11, is a character string indicating to the user that information input to the input field F41 is the lot identification information. In the example illustrated in FIG. 11, nothing is input to the input field F41. The input of the lot identification information to the input field F41 may be performed according to selection of the lot identification information according to a pull-down menu or may be performed by direct input by an input device such as a keyboard.

The button B61 is a button for receiving operation of deciding the lot identification information input to the input field F41 as lot identification information for identifying the target lot and receiving operation for displaying the history information display image P4. When selection operation on the button B61 is performed, the server 30 decides the lot identification information input to the input field F41 as lot identification information for identifying the target lot. Then, the server 30 deletes the display of the history information display operation reception image P6 and displays the history information display image P4. Here, when a predetermined second gray-out condition is satisfied, the server 30 grays out the button B61 and does not receive the selection operation on the button B61. On the other hand, when the second gray-out condition is not satisfied, the server 30 releases the gray-out of the button B61 and receives the selection operation on the button B61. According to such gray-out, the server 30 can suppress erroneous operation by the user. The second gray-out condition is, for example, a condition including the following condition 2A.
Condition 2A: the lot identification information is not input to the input field F41

When the condition 2A is satisfied, the server 30 determines that the second gray-out condition is satisfied. On the other hand, when the condition 2A is not satisfied, the server 30 determines that the second gray-out condition is not satisfied.

Here, in the example illustrated in FIG. 11, the lot identification information is not input to the input field F41 as explained above. Therefore, in the example, the button B61 is grayed out.

The server 30 that can cause the terminal device 40 to display the image such as the history information display image P4 as explained above is, for example, a workstation, a desktop PC (Personal Computer), a notebook PC, or the like but is not limited to these. The server 30 may be configured integrally with the information processing device 20.

The server 30 is communicably connected to the information processing device 20 by wired or wireless communication. A communication network connecting the server 30 and the information processing device 20 may be, for example, a LAN in a facility in which the plurality of managed devices 10 are installed, may be the Internet, may be a mobile communication network, or may be another communication network. In the following explanation, as an example, a case in which the communication network connecting the server 30 and the information processing device 20 is the Internet is explained. In this case, the server 30 is a cloud server.

The server 30 is communicably connected to the terminal device 40 by wired or wireless communication. In the example illustrated in FIG. 1, the server 30 is communicably connected to the terminal device 40 by wireless communication. A communication network connecting the server 30 and the terminal device 40 may be, for example, a LAN in a facility in which the server 30 is installed, the Internet, a mobile communication network, or another communication network. In the following explanation, as an example, a case in which the communication network connecting the server 30 and the terminal device 40 is the Internet is explained.

### Hardware Configuration of the Server

A hardware configuration of the server 30 is explained below with reference to FIG. 12. FIG. 12 is a diagram illustrating an example of the hardware configuration of the server 30.

The server 30 includes, for example, a processor 31, a storage unit 32, and a communication unit 33. These component elements are communicably connected to one another via a bus. The server 30 communicates with each of the information processing device 20 and the terminal device 40 via the communication unit 33.

The processor 31 is, for example, a central processing unit (CPU). Instead of the CPU, the processor 31 may be another processor such as a field programmable gate array (FPGA). The processor 31 executes various programs stored in the storage unit 32.

The storage unit 32 is, for example, a storage device including a hard disk drive (HDD), a solid-state drive (SSD), an electrically erasable programmable read-only memory (EEPROM), a read-only memory (ROM), and a random access memory (RAM). Instead of being built in the server 30, the storage unit 32 may be an external storage device connected to a digital input/output port such as a USB (Universal Serial Bus). The storage unit 32 stores various information, various images, and various programs to be processed by the server 30. That is, the various information stored by the server 30 are stored in the storage unit 32.

The communication unit 33 is a communication device including, for example, a digital input/output port such as a USB, an Ethernet (registered trademark) port, and an antenna for wireless communication.

### Functional Configuration of the Server

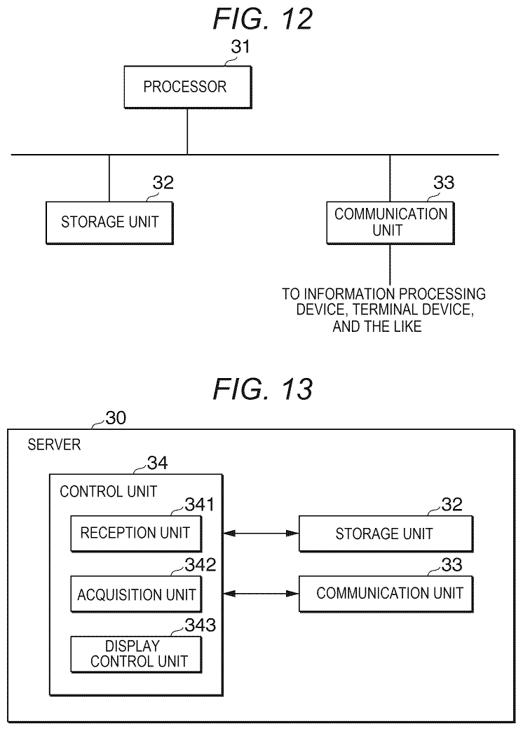

A functional configuration of the server 30 is explained below with reference to FIG. 13. FIG. 13 is a diagram illustrating an example of the functional configuration of the server 30.

The server 30 includes the storage unit 32, the communication unit 33, and a control unit 34.

The control unit 34 controls the entire server 30. The control unit 34 includes a reception unit 341, an acquisition unit 342, and a display control unit 343. These functional units provided in the control unit 34 are implemented by, for example, the processor 31 executing various programs stored in the storage unit 32. A part or all of the functional units may be hardware functional units such as a large scale integration (LSI) or an application specific integrated circuit (ASIC).

The reception unit 341 receives various information and various kinds of operation from a device communicably connected to the server 30.

The acquisition unit 342 acquires, for each of the plurality of managed devices 10, state information about the managed device 10 from the managed device 10 via the information processing device 20. The acquisition unit 342 may be configured to directly acquire the state information from the managed device 10 not via the information processing device 20.

The display control unit 343 generates various images according to operation received via the reception unit 341. The display control unit 343 transmits the generated images to the terminal device 40 and displays the images on the terminal device 40.

Processing in which the Server Displays a History Information Display Image

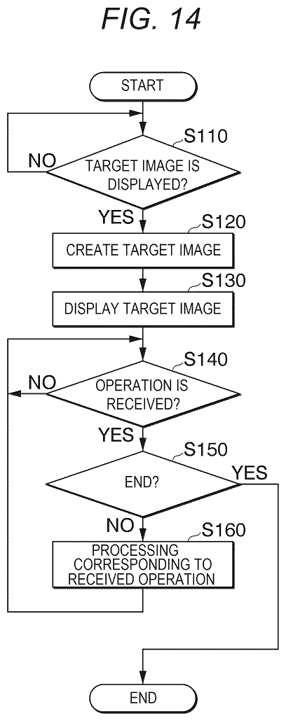

Processing in which the server 30 displays the history information display image P4 is explained with reference to FIG. 14. In the following explanation, for convenience of explanation, the lot search image P3 or the history information display operation reception image P6 is referred to as target image. FIG. 14 is a diagram illustrating an example of a flow of the processing in which the server 30 displays the history information display image P4. In the following explanation, as an example, a case in which the target image is displayed on the terminal device 40 at timing before processing in step S110 illustrated in FIG. 14 is performed is explained. In the following explanation, as an example, a case in which lot information is already stored in the server 30 at the timing is explained.

The control unit 34 stays on standby until operation of displaying the target image, that is, selection operation on the button B21 or the button B22 is received via the terminal device 40 (step S110). In FIG. 14, the processing in step S110 is indicated by “target image is displayed?.”

When determining that the operation of displaying the target image is received via the terminal device 40 (step S110—YES), the control unit 34 generates the target image (step S120). A method of generating the target image in step S120 may be a known method or may be a method to be developed in future.

Subsequently, the control unit 34 transmits the target image generated in step S120 to the terminal device 40 and causes the terminal device 40 to display the target image (step S130).

Subsequently, the control unit 34 stays on standby until operation is received via the target image displayed on the terminal device 40 (step S140). In FIG. 14, the processing of step S140 is indicated by “operation is received?.”

When it is determined that operation has been received via the target image displayed on the terminal device 40 (step S140—YES), the control unit 34 determines whether the received operation is operation of ending the processing of the flowchart illustrated in FIG. 14 (step S150). The determination processing in step S150 by the control unit 34 may be performed by a known method or may be performed by a method to be developed in future. In FIG. 14, the processing in step S150 is indicated by “end?.”

When determining that the operation received in step S140 is the operation of ending the processing of the flowchart illustrated in FIG. 14 (step S150—YES), for example, the control unit 34 deletes the display of the target image from the terminal device 40 and ends the processing of the flowchart illustrated in FIG. 14.

On the other hand, when determining that the operation received in step S140 is not the operation of ending the processing of the flowchart illustrated in FIG. 14 (step S150-NO), the control unit 34 performs processing corresponding to the received operation (step S160). The processing includes processing of displaying the history information display image P4. Here, since the processing performed by the control unit 34 in step S160 is already explained with reference to FIGS. 4 and 11, detailed explanation thereof is omitted. Since details of the history information display image P4 displayed by the processing of step S160 are already explained with reference to FIGS. 5 to 10, detailed explanation thereof is omitted.

After the processing in step S160 is performed, the control unit 34 transitions to step S140 and stays on standby again until an operation is received via the target image displayed on the terminal device 40.

According to the processing explained above, the server 30 causes the terminal device 40 to display the history information display image P4 for displaying history information included in lot related information of lot information indicating a selected target lot among the lots indicated by the one or more pieces of lot information stored in the storage unit 32. Accordingly, the server 30 can improve traceability about a molded product.

The molding management system 1 explained above may include the terminal device 40.

The method of displaying the history information display image P4 via the history information display operation reception image P6 explained above is, for example, a method used, for example, when an identification tag on which lot identification information for identifying a target lot is described or a lot label on which a barcode or the like indicating the lot identification information is at hand. On the other hand, the method of displaying the history information display image P4 via the lot search image P3 explained above is, for example, a method used, for example, when a person in charge of a production technique of an office performs operation of the terminal device 40 and the lot label is not at hand.

The search for a lot explained above may be performed using, as a search key, a time period in which the lot was not normally operating. In this case, the lot related information includes information indicating the time period.

The search for a lot explained above may be performed using, as a search key, one or more pieces of information included in the injection molding device related information. In this case, the lot related information includes the injection molding device related information. Injection molding device related information included in lot related information concerning a certain lot is information concerning an injection molding device that performs molding of a product of the lot and is information including, for example, operation state information indicating an operation state of the injection molding device and detection information about the injection molding device as explained above. Accordingly, the server 30 can more reliably improve traceability about a product.

The search for a lot explained above may be performed using any character string as a search key. In this case, when receiving any character string, the server 30 specifies information including the received character string out of one or more pieces of information included in the lot related information and displays a list of lot information indicating lots identified by lot identification information associated with the specified information. Accordingly, the server 30 can make a search for a lot by the user easier.

The contents explained above may be combined in any manner.

### APPENDIXES

### Appendixes 1

A molding management system including a server communicably connected to a terminal device, the molding management system managing production of a product in a production process including an injection molding process for the product by an injection molding device, wherein the server includes: a storage unit configured to store one or more pieces of lot information in which lot identification information for identifying a lot of the product and lot related information including history information indicating a history concerning the product of at least the lot as one or more pieces of information concerning the lot of the product are associated with each other; and a control unit configured to cause the terminal device to display a history information display image for displaying the history information included in the lot related information of the lot information indicating a selected target lot among the lots indicated by the one or more pieces of lot information stored in the storage unit.

### Appendixes 2

The molding management system described in [1], wherein
the history information included in the lot related information of the lot information indicating the target lot includes lot information change history information indicating a history concerning a change of the lot information indicating the target lot, and
the history information display image includes the lot information change history information.

### Appendixes 3

The molding management system described in [1] or [2], wherein the history information included in the lot related information of the lot information indicating the target lot includes material history information indicating a history concerning use of a material of the product of the target lot, and the history information display image includes the material history information.

### Appendixes 4

The molding management system described in any one of [1] to [3], wherein the history information included in the lot related information of the lot information indicating the target lot includes work process change history information indicating a history concerning a change of a work process performed on the product of the target lot, and the history information display image includes the work process change history information.

### Appendixes 5

The molding management system described in any one of [1] to [4], wherein the history information included in the lot related information of the lot information indicating the target lot includes lot management history information indicating a history concerning management of the target lot, and the history information display image includes the lot management history information.

### Appendixes 6

The molding management system described in any one of [1] to [5], wherein the history information included in the lot related information of the lot information indicating the target lot includes quality inspection history information indicating a history concerning inspection of quality of the product of the target lot, and the history information display image includes the quality inspection history information.

### Appendixes 7

The molding management system described in [6], wherein the history information display image includes a quality inspection history information display operation reception image for receiving a quality inspection history information display operation for displaying a list of the quality inspection history information, and, when receiving the quality inspection history information display operation via the quality inspection history information display operation reception image, the control unit displays a list of the quality inspection history information in the history information display image.

### Appendixes 8

The molding management system described in any one of [1] to [7], wherein, when receiving operation of displaying a terminal image for receiving operation of displaying a desired image among images for receiving operation for a respective plurality of functions, the control unit causes the terminal device to display the terminal image, the terminal image includes an image for receiving operation of displaying a first history information display image display operation reception image, and the first history information display image display operation reception image is an image for receiving operation of displaying the history information display image.

### Appendixes 9

The molding management system described in any one of [1] to [8], wherein, when receiving operation of displaying a lot search image for searching for a desired piece of the lot information among one or more pieces of the lot information stored in the storage unit, the control unit causes the terminal device to display the lot search image, and the lot search image includes a second history information display image display operation reception image for receiving operation of displaying the history information display image.

### Appendixes 10

The molding management system described in any one of [1] to [9], wherein the lot related information includes, as the one or more pieces of information, injection molding device related information concerning an injection molding device that performs molding of the product of the lot identified by the lot identification information associated with the lot related information, and the injection molding device related information includes at least one of operation state information indicating an operation state of the injection molding device and detection information detected by each of one or more sensors attached to the injection molding device.

### Appendixes 11

The molding management system described in any one of [1] to [10], wherein the lot related information includes quality information about the product of the lot identified by the lot identification information associated with the lot related information.

### Appendixes 12

The molding management system described in any one of [1] to [11], wherein the lot related information includes process information indicating a work process currently performed on the product of the lot identified by the lot identification information associated with the lot related information.

### Appendixes 13

The molding management system described in any one of [1] to [12], wherein the molding management system includes the terminal device.

### Appendixes 14

The molding management system described in any one of [1] to [13], wherein the molding management system includes the injection molding device.

### Appendixes 15

A molding management system including a server communicably connected to a terminal device, the molding management system managing production of a product in a production process including an injection molding process for the product by an injection molding device, wherein the server includes: a storage unit configured to store one or more pieces of lot information in which lot identification information for identifying a lot of the product and lot related information including first history information indicating a history of a first type concerning at least the lot as one or more pieces of information concerning the lot of the product and second history information indicating a history of a second type concerning the lot are associated with each other; and a control unit configured to cause the terminal device to display a history information display image for displaying the first history information and the second history information included in the lot related information of the lot information indicating a selected target lot among the lots indicated by the one or more pieces of lot information stored in the storage unit.

Although the embodiment of the present disclosure is explained in detail above with reference to the drawings, a specific configuration is not limited to the embodiment and may be, for example, changed, replaced, or deleted without departing from the gist of the present disclosure.

A program for implementing a function of any component in the device explained above may be recorded in a computer-readable recording medium and the program may be read and executed by a computer system. Here, the device is, for example, the injection molding device 11, the information processing device 20, the server 30, or the terminal device 40. Here, the “computer system” referred to here includes an operating system (OS) and hardware such as peripheral equipment. The “computer-readable recording medium” refers to a portable medium such as a flexible disc, a magneto-optical disc, a ROM, or a compact disk (CD)-ROM or a storage device such as a hard disk built in the computer system. Further, the “computer-readable recording medium” includes a medium that retains a program for a certain period of time like a volatile memory inside a computer system serving as a server or a client when a program is transmitted via a network such as the Internet or a communication line such as a telephone line.

The program may be transmitted from a computer system in which the program is stored in a storage device or the like to another computer system via a transmission medium or by a transmission wave in the transmission medium. Here, the “transmission medium” for transmitting the program refers to a medium including a function of transmitting information like a network such as the Internet or a communication line such as a telephone line.

The program may be a program for implementing a part of the functions explained above. Further, the program may be a so-called differential file or differential program that can implement the functions explained above in combination with a program already recorded in the computer system.

What is claimed is:

1. A molding management system comprising a server communicably connected to a terminal device, the molding management system managing production of a product in a production process including an injection molding process for the product by an injection molding device, wherein
the server includes:
a storage unit configured to store one or more pieces of lot information in which lot identification information for identifying a lot of the product and lot related information including history information indicating a history concerning the product of at least the lot as one or more pieces of information concerning the lot of the product are associated with each other; and
a control unit configured to cause the terminal device to display a history information display image for displaying the history information included in the lot related information of the lot information indicating a selected target lot among the lots indicated by the one or more pieces of lot information stored in the storage unit.

2. The molding management system according to claim 1, wherein
the history information included in the lot related information of the lot information indicating the target lot includes lot information change history information indicating a history concerning a change of the lot information indicating the target lot, and
the history information display image includes the lot information change history information.

3. The molding management system according to claim 1, wherein
the history information included in the lot related information of the lot information indicating the target lot includes material history information indicating a history concerning use of a material of the product of the target lot, and
the history information display image includes the material history information.

4. The molding management system according to claim 1, wherein
the history information included in the lot related information of the lot information indicating the target lot includes work process change history information indicating a history concerning a change of a work process performed on the product of the target lot, and
the history information display image includes the work process change history information.

5. The molding management system according to claim 1, wherein
the history information included in the lot related information of the lot information indicating the target lot includes lot management history information indicating a history concerning management of the target lot, and
the history information display image includes the lot management history information.

6. The molding management system according to claim 1, wherein
the history information included in the lot related information of the lot information indicating the target lot includes quality inspection history information indicating a history concerning inspection of quality of the product of the target lot, and
the history information display image includes the quality inspection history information.

7. The molding management system according to claim 6, wherein
the history information display image includes a quality inspection history information display operation reception image for receiving a quality inspection history information display operation for displaying a list of the quality inspection history information, and
when receiving the quality inspection history information display operation via the quality inspection history information display operation reception image, the control unit displays a list of the quality inspection history information in the history information display image.

8. The molding management system according to claim 1, wherein
when receiving operation of displaying a terminal image for receiving operation of displaying a desired image among images for receiving operation for a respective plurality of functions, the control unit causes the terminal device to display the terminal image,
the terminal image includes an image for receiving operation of displaying a first history information display image display operation reception image, and
the first history information display image display operation reception image is an image for receiving operation of displaying the history information display image.

9. The molding management system according to claim 1, wherein
when receiving operation of displaying a lot search image for searching for a desired piece of the lot information among one or more pieces of the lot information stored in the storage unit, the control unit causes the terminal device to display the lot search image, and
the lot search image includes a second history information display image display operation reception image for receiving operation of displaying the history information display image.

10. The molding management system according to claim 1, wherein
the lot related information includes, as the one or more pieces of information, injection molding device related information concerning an injection molding device that performs molding of the product of the lot identified by the lot identification information associated with the lot related information, and
the injection molding device related information includes at least one of operation state information indicating an operation state of the injection molding device and detection information detected by each of one or more sensors attached to the injection molding device.

11. The molding management system according to claim 1, wherein the lot related information includes quality information about the product of the lot identified by the lot identification information associated with the lot related information.

12. The molding management system according to claim 1, wherein the lot related information includes process information indicating a work process currently performed on the product of the lot identified by the lot identification information associated with the lot related information.

13. The molding management system according to claim 1, wherein the molding management system includes the terminal device.

14. The molding management system according to claim 1, wherein the molding management system includes the injection molding device.

15. A molding management system comprising a server communicably connected to a terminal device, the molding management system managing production of a product in a production process including an injection molding process for the product by an injection molding device, wherein
the server includes:
a storage unit configured to store one or more pieces of lot information in which lot identification information for identifying a lot of the product and lot related information including first history information indicating a history of a first type concerning at least the lot as one or more pieces of information concerning the lot of the product and second history information indicating a history of a second type concerning the lot are associated with each other; and
a control unit configured to cause the terminal device to display a history information display image for displaying the first history information and the second history information included in the lot related information of the lot information indicating a selected target lot among the lots indicated by the one or more pieces of lot information stored in the storage unit.
